(19) United States
(12) Patent Application Publication
(10) Pub. No.: US 2025/0370424 A1
(43) Pub. Date: Dec. 4, 2025

(54) NUMERICALLY CONTROLLED OSCILLATOR KERNEL

(71) Applicant: International Business Machines Corporation, Armonk, NY (US)

(72) Inventors: Timothy Lindquist, Rochester, MN (US); Jarrett Betke, Hoffman Estates, IL (US); George Russell ZETTLES, IV, Rochester, MN (US); Scott M. Willenborg, Stewartville, MN (US); AUSTIN CARTER, Olmsted, MN (US); George Paulik, Rochester, MN (US); Daniel Ramirez, Rochester, MN (US); Bryce Snell, Rochester, MN (US); Kevin Daniel Escobar, Rochester, MN (US)

(21) Appl. No.: 18/677,176

(22) Filed: May 29, 2024

(51) Int. Cl. G05B 19/19; G06N 10/20

(52) U.S. Cl. CPC G05B 19/19; G06N 10/20; G05B 2219/43139

(57) ABSTRACT

Systems and techniques that facilitate qubit differentiation with a numerically controlled oscillator (NCO) kernel are provided. One or more embodiments described herein can comprise a system, which can comprise a memory that can store computer executable components. The system can also comprise a processor, operably coupled to the memory that can execute the computer executable components stored in memory. The computer executable components can comprise an input component that receives a setpoint having a phase or a frequency for a quantum signal as input. The computer executable components can further comprise an execution component that generates a kernel based on the setpoint for the quantum signal using a logic block in an integrated circuit, wherein the logic block comprises an NCO that generates the kernel using a reading of a waveform lookup table.

### BACKGROUND

The subject disclosure relates to quantum state determination, and more specifically, to a numerically controlled oscillator (NCO) kernel for qubit state determination.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, and/or computer program products that facilitate a numerically controlled oscillator (NCO) kernels for qubit state determination are provided.

According to an embodiment, a system can comprise a processor that executes computer executable components stored in memory. The computer executable components can comprise an input component that receives a setpoint having a phase or a frequency for a quantum signal as input. The computer executable components can further comprise an execution component that generates a kernel based on the setpoint for the quantum signal using a logic block in an integrated circuit, wherein the logic block comprises an NCO that generates the kernel using a reading of a waveform lookup table. An advantage of this system is that it reduces memory size requirements for scaling quantum systems, and it eliminates pre-compute times and load times for kernel generation.

According to another embodiment, a unit cell of an Application-Specific Integrated Circuit (ASIC) can comprise a memory that stores a waveform lookup table and a logic block coupled to the memory, wherein the logic block comprises registers that store a setpoint having a phase or a frequency for a quantum signal and an NCO, coupled to the registers, that generates a kernel based on the setpoint for the quantum signal using a reading of the waveform lookup table. An advantage of this system is that it reduces memory size requirements for scaling quantum systems, and it eliminates pre-compute times and load times for kernel generation.

According to another embodiment, a computer program product comprising a computer readable storage medium having program instructions embodied therewith, the program instructions executable by a processor to cause the processor to receive, by the processor, a setpoint having a phase or a frequency for a quantum signal as input. The program instructions can further be executable by the processor to cause the processor to generate, by the processor, a kernel based on the setpoint for the quantum signal using a logic block in an integrated circuit, wherein the logic block comprises a numerically controlled oscillator (NCO) that generates the kernel using a reading of a waveform lookup table. An advantage of this system is that it reduces memory size requirements for scaling quantum systems, and it eliminates pre-compute times and load times for kernel generation.

### DESCRIPTION OF THE DRAWINGS

FIG. 1 illustrates block diagram of an example, non-limiting system that can facilitate an NCO kernel for qubit state determination in accordance with one or more embodiments described herein.

FIG. 2 illustrates block diagram of an example, non-limiting system that can facilitate an NCO kernel for qubit state determination in accordance with one or more embodiments described herein.

FIG. 3 illustrates a non-limiting example diagram of a shared waveform lookup table for more than one logic block comprising an NCO kernel in accordance with one or more embodiments described herein.

FIG. 4 illustrates a non-limiting example diagram of utilizing a subset of a waveform lookup table for generating an NCO kernel in accordance with one or more embodiments described herein.

FIGS. 5 illustrates a block diagram of an example, non-limiting quantum system that can at least partially facilitate an NCO kernel for qubit state determination for in accordance with one or more embodiments described herein.

FIG. 6 illustrates a non-limiting example diagram of resource utilization and load time of NCO kernels in accordance with one or more embodiments described herein.

FIG. 7 illustrates a flow diagram of an example, non-limiting, computer implemented method that facilitates an NCO kernel for qubit state determination in accordance with one or more embodiments described herein.

FIGS. 8 illustrates a flow diagram of an example, non-limiting, computer implemented method that facilitates an NCO kernel for qubit state determination in accordance with one or more embodiments described herein.

FIGS. 9 illustrates a flow diagram of an example, non-limiting, computer implemented method that facilitates an NCO kernel for qubit state determination in accordance with one or more embodiments described herein.

FIG. 10 illustrates an example, non-limiting environment for the execution of at least some of the computer code in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

According to an embodiment, a system can comprise a processor that executes computer executable components stored in memory. The computer executable components can comprise an input component that receives a setpoint having a phase or a frequency for a quantum signal as input. The computer executable components can further comprise an execution component that generates a kernel based on the setpoint for the quantum signal using a logic block in an integrated circuit, wherein the logic block comprises a numerically controlled oscillator (NCO) that generates the kernel using a reading of a waveform lookup table. An advantage of this system is that it reduces memory size requirements for scaling quantum systems, and it eliminates pre-compute times and load times for kernel generation.

In one or more embodiments of the aforementioned system, the execution component can generate one or more convolutions of a sample of an incoming signal in connection with a qubit of a quantum system with the kernel. In some embodiments of the aforementioned system, the execution component can accumulate the one or more convolutions to determine a qubit state of the qubit. In one or more embodiments of the aforementioned system, the waveform lookup table can store a quarter of a sine wave, wherein the execution component performs a translation on the quarter of the sine wave to generate the kernel based on the setpoint for the quantum signal. In various embodiments of the aforementioned system, the execution component can generate more than one kernel using a plurality of logic blocks in the integrated circuit, and wherein the waveform lookup table is shared between the plurality of logic blocks. In some embodiments of the aforementioned system, the more than one logic blocks can be configured to determine different qubit measurements. In one or more embodiments of the aforementioned system, the waveform lookup table can comprise a fixed memory size in the integrated circuit. In one or more embodiments of the aforementioned system, the execution component can scale the kernel by a scaling factor. In one or more embodiments of the aforementioned system, the logic block in the integrated circuit can be implemented using a Field-Programmable Gate Array (FPGA) or an Application-Specific Integrated Circuit (ASIC). Advantages of this system include reducing memory requirements for scaling quantum systems, enabling configurable kernels at run-time, and/or eliminating length constraints of kernels. Advantages of this system further include reducing computational costs and/or improving efficiency of quantum state determination. Advantages of this system even further include eliminating load times or pre-compute times or kernels for quantum state determination.

According to some embodiments, the above-described computer system can be implemented as a computer-implemented method or as a computer program product.

In quantum computing, it can be desirable to determine states of one or more qubits of a quantum system by performing a quantum experiment. To determine a qubit state, a kernel (e.g., an array of datapoints) representing a waveform at a frequency of a qubit readout signal (e.g., a signal that provides information about the state of the qubit) can be pre-computed on a host computer and loaded into memory of an integrated circuit that performs the quantum experiment.

However, the amount of logic required to distinguish the readout signal increases linearly as the number of qubits comprised in the quantum system increases. Moreover, each qubit differentiation requires a separate kernel, and integrated circuits can comprise finite resources, limiting the number of kernels that can be pre-computed and loaded into the integrated circuit. Limited resources of integrated circuits can also place constraints on lengths of the kernels. Further, loading and pre-computing each kernel can be time-consuming, especially as the size of the quantum system increases. Accordingly, it can be desirable to reduce memory requirements of the kernel, as well as reduce loading time and pre-computing time of the kernels.

In view of the problems discussed above, in relation to qubit differentiation, the present disclosure can be implemented to produce a solution to one or more of these problems by implementing an NCO kernel. Specifically, a kernel can be generated during run-time by an NCO accessing a shared memory unit for a frequency and phase received as input. The NCO kernel eliminates the need to pre-compute kernel values and load the kernel into memory of an integrated circuit. Further, the NCO can generate a kernel for any frequency and phase received as input rather than pre-computing and loading a different kernel for each qubit distinction. Moreover, by utilizing a lookup table of fixed size for the NCO to access as a shared memory unit, memory requirements can be maintained as the quantum system scales to comprise more qubits.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

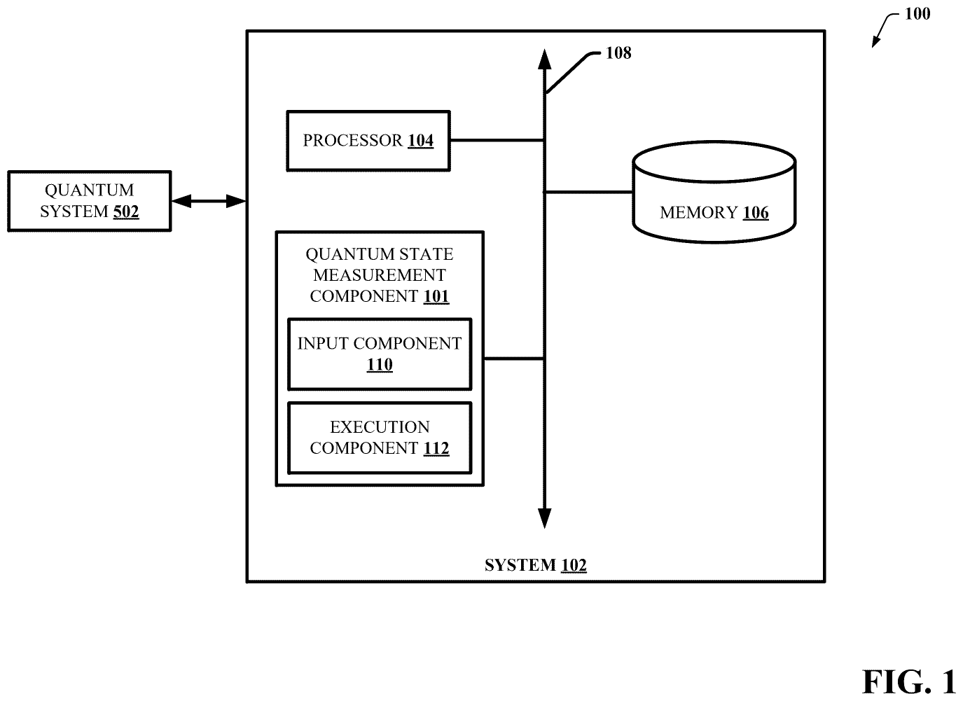

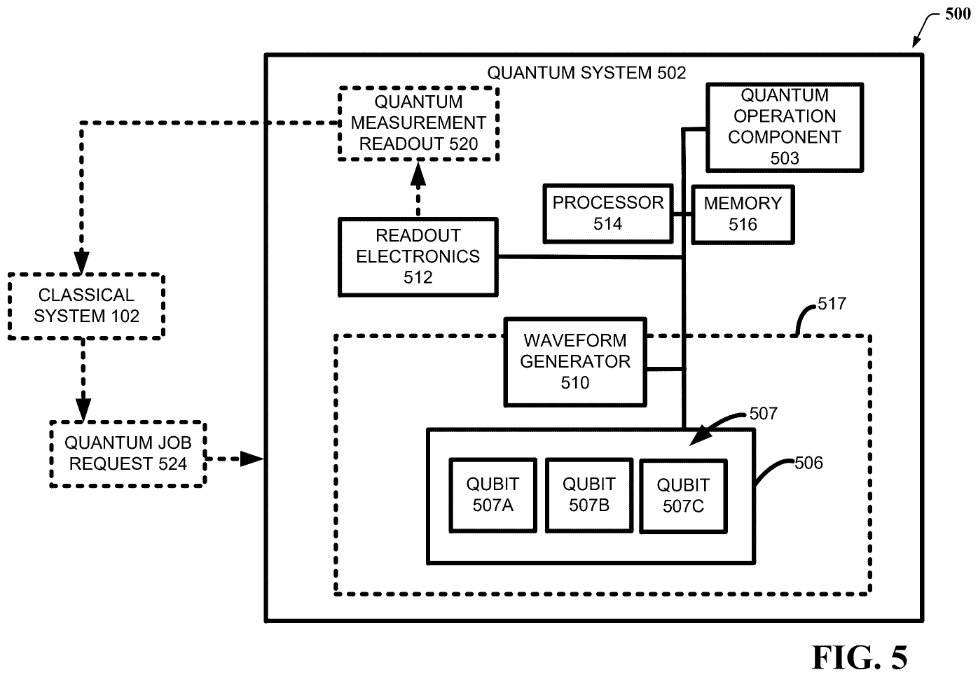

FIG. 1 illustrates block diagram of an example, non-limiting system 100 that can facilitate an NCO kernel for qubit state determination in accordance with one or more embodiments described herein. That is, the non-limiting system 100 can facilitate an NCO kernel for qubit state determination, in combination with employment of a quantum system 502 (FIG. 5).

Aspects of systems (e.g., system 102 and the like), apparatuses or processes in various embodiments of the present invention can constitute one or more machine-executable components embodied within one or more machines (e.g., embodied in one or more computer readable mediums (or media) associated with one or more machines). Such components, when executed by the one or more machines, e.g., computers, computing devices, virtual machines, etc. can cause the machines to perform the operations described. System 102 can comprise processor 104, memory 106, system bus 108. input component 110, and execution component 112.

The system 100 and/or the components of the system 100 can be employed to use hardware and/or software to solve problems that are highly technical in nature (e.g., related to quantum state measurements, kernel convolutions, radio frequency engineering, etc.), that are not abstract and that cannot be performed as a set of mental acts by a human. Further, some of the processes performed may be performed by specialized computers for carrying out defined tasks related to quantum systems. The system 100 and/or components of the system can be employed to solve new problems that arise through advancements in technologies mentioned above, computer architecture, and/or the like. The system 100 can provide technical improvements to quantum state determination by reducing memory requirements for scaling quantum systems, improving efficiency of quantum state determination, and/or improving hardware efficiency for quantum state determination etc.

Discussion turns briefly to processor 104, memory 106 and bus 108 of system 100. For example, in one or more embodiments, the system 100 can comprise processor 104 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s).

In one or more embodiments, system 100 can comprise a computer-readable memory (e.g., memory 106) that can be operably connected to the processor 104. Memory 106 can store computer-executable instructions that, upon execution by processor 104, can cause processor 104 and/or one or more other components of system 100 (e.g., quantum state measurement component 101, input component 110, and/or execution component 112) to perform one or more actions. In one or more embodiments, memory 106 can store computer-executable components (e.g., quantum state measurement component 101, input component 110, and/or execution component 112).

System 100 and/or a component thereof as described herein, can be communicatively, electrically, operatively, optically and/or otherwise coupled to one another via bus 108. Bus 108 can comprise one or more of a memory bus, memory controller, peripheral bus, external bus, local bus, and/or another type of bus that can employ one or more bus architectures. One or more of these examples of bus 108 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to the processor 104 and/or memory 106 described above, system 100 can comprise one or more computer and/or machine readable, writable and/or executable components and/or instructions that, when executed by processor 104, can enable performance of one or more operations defined by such component(s) and/or instruction(s).

In various embodiments, a quantum system (e.g., quantum system 502) can comprise m qubits, where it is desirable to determine states of one or more of the m qubits. In various embodiments, qubit state measurement component 101 can facilitate quantum state measurement of a qubit of the quantum system via an NCO kernel. In various instances, qubit state measurement component 101 can comprise sub-components (e.g., input component 110, execution component 112).

In various embodiments, the input component 110 can receive a setpoint having a frequency and/or a phase for a quantum signal as input. In various instances, the frequency or phase can be selected based on a desired phase or frequency to differentiate a qubit of the quantum system with an NCO kernel at (e.g., for matched filtering to detect a known signal within a noisy or distorted input signal). In various aspects, the input component 110 can receive one or more frequencies or one or more phases as input. That is, the input component 110 can receive a different phase or frequency for determination of a state of each qubit of the quantum system. In various embodiments, the phase or frequency can define a waveform that matches a quantum signal (e.g., radio frequency tone) that is transmitted through the qubit in the quantum system to determine the state of the qubit (e.g., match a readout tone sent through the quantum system). For instance, the quantum signal can be transmitted into a cryostat and pass through the qubit via a readout resonator. In some cases, the frequency or phase can define an ideal signal of the quantum signal that is transmitted through the quantum system. In various embodiments, a unit cell of the integrated circuit can comprises registers that store the setpoint having the phase or the frequency.

In various embodiments, the input component 110 can receive an incoming quantum signal. In various cases, the incoming quantum signal can be the quantum signal that was transmitted through the qubit. More specifically, the transmitted quantum signal can be influenced by the state of the qubit and received to determine the state of the qubit. In various aspects, the incoming quantum signal can be received and digitized via an analog-to-digital converter (ADC) coupled to the logic block. The ADC can convert continuous analog signals (e.g., the quantum signal) into discrete digital representations (e.g., discrete set of values). That is, the input component 110 can receive the quantum signal and convert the quantum signal into a discrete set of values that represent the quantum signal.

In one or more embodiments, the execution component 112 can generate a logic block in an integrated circuit. In various instances, the integrated circuit can be, but is not limited to, a programmable logic device (PLD), a field programmable gate array (FPGA), a CPU, a microchip, an application-specific integrated circuit (ASIC), and/or the like.

In various aspects, the logic block can comprise an NCO, coupled to the registers, to generate a kernel based on the setpoint having the phase or frequency received as input. Thus, the kernel can be convolved with the received quantum signal to determine the state of the qubit. In various aspects, generation of the kernel can be executed during run-time rather than pre-computing and loading the kernel. In other words, the kernel can be generated on demand based on a desired phase or frequency, reducing memory space utilization of the integrated circuit and eliminating pre-compute times and load times.

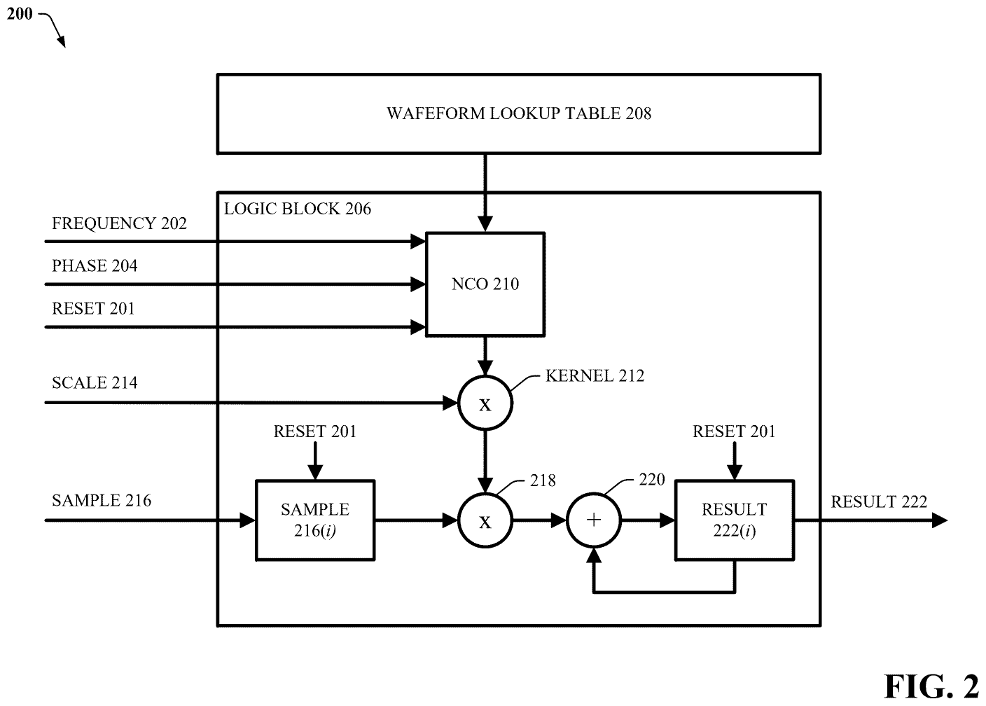

FIG. 2 illustrates block diagram of an example, non-limiting system 200 that can facilitate an NCO kernel for qubit state determination in accordance with one or more embodiments described herein. Repetitive description of like elements employed in other embodiments described herein is omitted for sake of brevity.

In various embodiments, the input component 110 can receive a frequency 202 and a phase 204. In various aspects, the execution component 112 can generate a logic block 206 that comprises an NCO 210. In various instances, NCO 210 can receive digital control inputs that specify a desired frequency and phase of an output waveform. That is, the input component 110 can input the frequency 202 and the phase 204 into the NCO 210 to generate a corresponding waveform via waveform lookup table 208. Frequency 202 and phase 204 can comprise any suitable digital format to input into NCO 210 (e.g., binary numbers, floating-point values, fixed-point representations). In some instances, the NCO 210 can generate the waveform by determining an address of the waveform lookup table 208. In various aspects, determining the address of the waveform lookup table 208 can comprise incrementing, by a phase accumulator, the frequency 202 and the phase 204 per clock cycle to generate output of the phase accumulator, wherein the output can be utilized to index the waveform lookup table 208. For instance, the phase accumulator can continuously add increments corresponding to frequency 202 and phase 204 to an accumulator value that represents a phase angle of the waveform. Therefore, output of the phase accumulator can serve as the address of waveform lookup table 208. Further, any suitable operations can be performed on the output of the phase accumulator to calculate a valid address of waveform lookup table 208 (e.g., truncating or rounding output of the phase accumulator to obtain a valid index within the range of the waveform lookup table 208). Accordingly, the NCO 210 can access waveform lookup table 208 to retrieve the waveform based on the output of the phase accumulator. For example, the waveform lookup table 208 can store a sinusoid waveform, and the output of the phase accumulator can index a section of the sinusoid waveform that corresponds to frequency 202 and phase 204. In any case, the input component 110 can convert the section of the waveform into an analog signal maintaining the desired characteristics (e.g., frequency 202, phase 204). The resulting waveform or analog signal can be considered the kernel 212. In other words, the NCO 210 can produce kernel 212 based on the frequency 202 and the phase 204. In various embodiments, the kernel 212 can comprise any suitable length. More specifically, because the kernel 212 is not pre-computed or loaded into memory before, the NCO 210 can output any number of values of kernel 212. In various cases, the waveform lookup table 208 can store any suitable waveform (e.g., sine wave, square wave, sawtooth wave, pulse wave, custom waveforms).

In some embodiments, the execution component 112 can scale the kernel 212 by a scale value (e.g., scaling parameter) 214. For instance, the execution component 112 can apply scale value 214 to kernel 212 if the kernel 212 does not align with a scale of the incoming quantum signal. Any suitable scale value 214 can be applied to, for example, normalize the kernel by adjusting magnitude or amplitude of the kernel.

In various aspects, the scaled kernel 212 can be convolved with a sample 216 of the incoming quantum signal. In various embodiments, the execution component 112 can sample the incoming quantum signal into n samples: a sample 216(1) to a sample 216(n). Each sample 216(i) of samples 216 can comprise a value of the discrete set of values that represent the incoming quantum signal. In various instances, the kernel 212 can comprise a set of discrete values defined by the waveform indexed by the NCO 210 in the waveform lookup table. As previously described, kernel 212 can be defined by a waveform that matches an ideal version of the incoming quantum signal. In various embodiments, the execution component 112 can generate a convolution of each sample 216(i) with each corresponding discrete value the kernel 212 via a multiply-accumulate unit that is coupled to the ADC. More specifically, the execution component 112 can compute a product 218 between the discrete value of the kernel 212 and the sample 216(i). Thus, the convolutions can be accumulated to determine a state of the qubit. Specifically, the product 218 can be accumulated with products between each sample 216(i) and the corresponding discrete value the kernel 212. After each iteration of generating a convolution of the sample 216 with the kernel 212, the product 218 can be added to a sum 220 that is the accumulation of the products in previous iterations. In various instances, each accumulation of the product 218 with the sum 220 can compute a result 222(i). If there is another iteration to convolve a reaming sample of sample 216 with kernel 212, the result 222(i) will become the sum 220 to accumulate with the following product 218. Following all iterations over sample 216, accumulation of each product 218 can be considered as result 222. In various aspects, result 222 can be used to determine the state of the qubit. In other words, the result 222 can indicate a degree of similarity between the waveform generated by the NCO 210 to represent an expected incoming quantum signal and the incoming quantum signal. For example, it can be concluded that the state of the qubit has changed if result 222 comprises a large negative value, indicating that the waveform generated by the NCO 210 and the incoming quantum signal differ significantly. As another example, it can be concluded that the state of the qubit has not changed if result 222 comprises a large positive value, indicating that the waveform generated by the NCO 210 and the incoming quantum signal have a high degree of similarity.

In various embodiments, the execution component 112 can utilize a reset flag 201 to facilitate computation of result 222. The reset flag 201 can be output by a controller of the unit cell in the integrated circuit and input into the NCO, the ADC, or the multiply-accumulate unit to coordinate acquisition of the setpoint. In various aspects, the reset flag 201 can comprise two states: an on state or an off state (e.g., represented by binary values). The reset flag 201 can be set for the NCO 210, sample 216, or result 222. When the reset flag 201 is in an on state for the NCO 210, the NCO 210 will produce the first kernel value for the frequency 202 and phase 204. When the reset flag 201 is in an off state, the NCO 210 will produce the ith kernel value. In other words, the reset flag 201 in an on for NCO 210 state indicates generation of a new kernel 212.

When the reset flag 201 is in an on state for sample 216, the execution component 112 will produce sample 216(1) of the sample 216 of the incoming quantum signal. When the reset flag 201 is in an off state for sample 216, the execution component 112 will produce sample 216(i). In various aspects, the reset flag 201 in an on state for sample 216 indicates a new sample 216 or a new incoming quantum signal.

When the reset flag 201 is in an on state for result 222, the execution component 112 will produce 0 as result 222. When the reset flag 201 is in an off state for result 222, the execution component 112 will produce result 222(i). In some cases, the reset flag 201 in an on state for result 222 can indicate a new sample 216 or a new incoming quantum signal is to be convolved with kernel 212. In other instances, the reset flag 201 in an on state for result 222 can indicate generation of new kernel 212. In either case, the reset flag 201 in an on state for result 222 will reset the accumulation of the convolutions to 0 to enable measuring of a new incoming quantum signal.

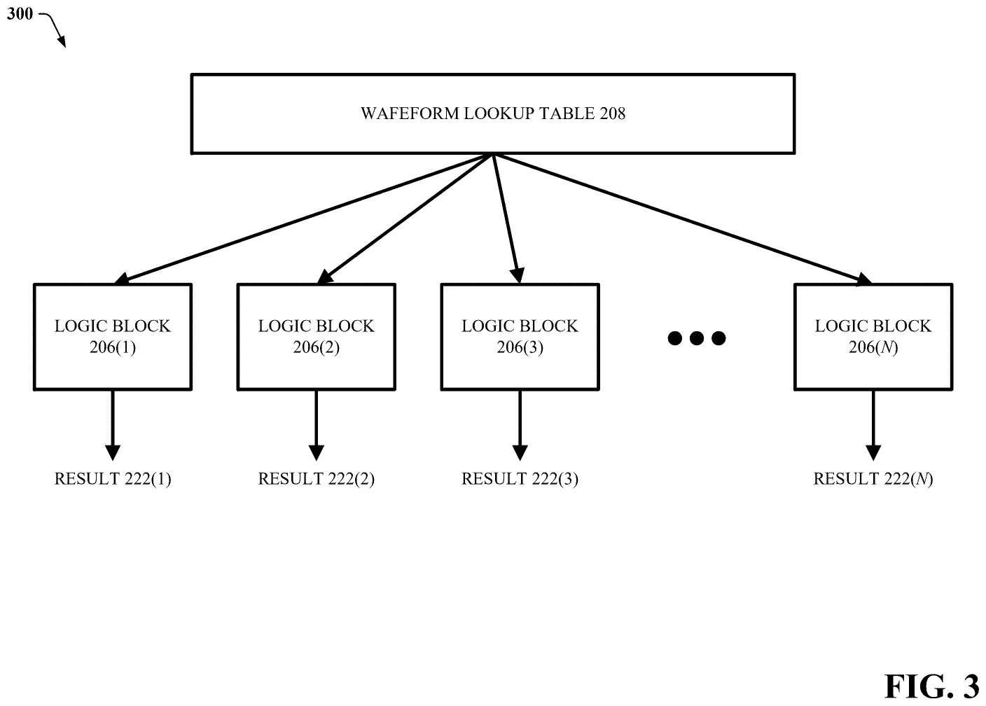

FIG. 3 illustrates a non-limiting example diagram 300 of a shared waveform lookup table for more than one logic block comprising an NCO kernel in accordance with one or more embodiments described herein. Repetitive description of like elements employed in other embodiments described herein is omitted for sake of brevity.

In various aspects, there can be one or more logic blocks 206. That is, for any positive integer N, the logic blocks 206 can comprise a logic block 206(1) to a logic block 206(N). In various embodiments, the waveform lookup table 208 can be shared between the one or more logic blocks 206. In other words, the waveform lookup table 208 can be a shared memory resource between the logic blocks 206. An advantage of the waveform lookup table 208 as a shared memory resource is that memory size requirements can be maintained as the quantum system scales. More specifically, as the quantum system scales to comprise more qubits, and accordingly logic blocks to generate NCO kernels, the waveform lookup table 208 can maintain a constant memory size.

In various aspects, any suitable schema can be implemented to facilitate access to the subset 402 among the logic blocks 206. For example, an arbitrator can be implemented to determine priority among the logic blocks 206 and coordinate access requests to the subset 402. In various instances, the arbitrator can be implemented using hardware, a combination of hardware and software, software, or software in execution.

In various embodiments, each of the logic blocks 206 can be configured to determine different qubit measurements. In various instances, the logic blocks 206 can be configured to, but are not limited to, determine standard basis measurements, higher-state measurements, Pauli measurements, Bell basis measurements, rotated basis measurements, projective measurements, or Positive Operator-Valued Measurements (POVMs). For example, logic block 206(1) can be configured to determine a higher-state measurement of a qubit (e.g., measurement of a qubit that is in a quantum state other than the standard basis states of 0 or 1) and logic block 206(2) can be configured to determine standard basis measurements.

In any case, the logic blocks 206 can generate results 222. That is, the logic blocks 206 can generate a result 222(1) to a result 222(N). More specifically, logic block 206(i) can generate result 222(i) for any positive integer i≤N. In some instances, each result of results 222 can be in connection with a different qubit of the quantum system. In other cases, each result of results 222 can be computed in accordance with a desired measurement type of the qubit (e.g., Pauli measurement, higher-state measurement). For example, convolving the kernel 212 with each sample 216 of the incoming quantum signal can comprise computing an inner product (e.g., scalar product).

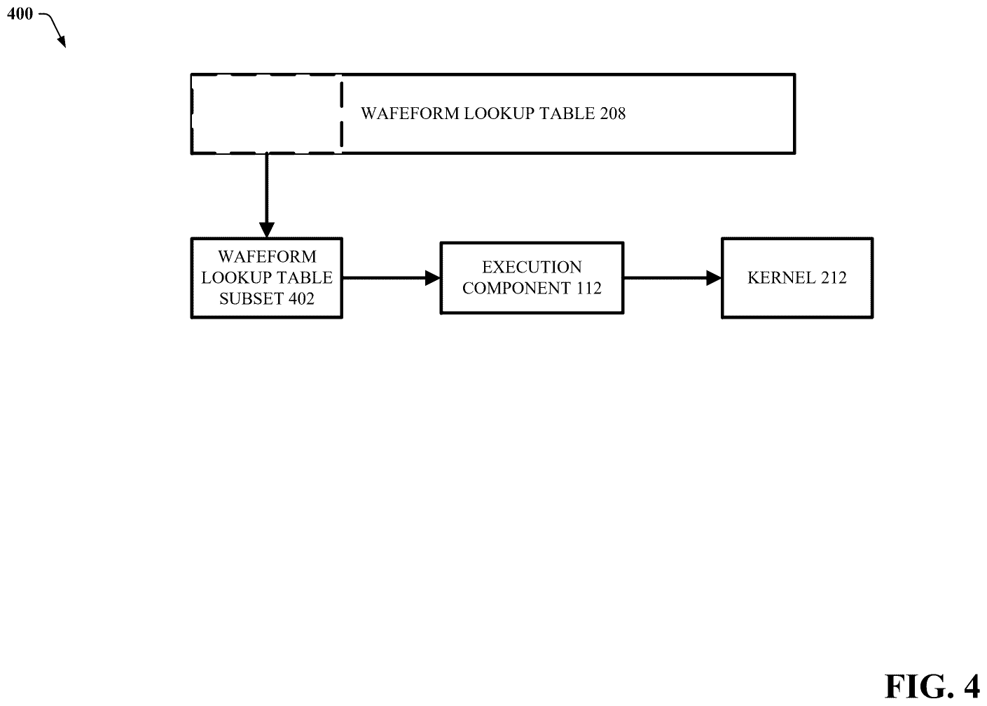

FIG. 4 illustrates a non-limiting example diagram 400 of utilizing a subset of a waveform lookup table for generating an NCO kernel in accordance with one or more embodiments described herein. Repetitive description of like elements employed in other embodiments described herein is omitted for sake of brevity.

In various embodiments, a subset 402 of the waveform lookup table 208 can be stored in memory of the integrated circuit in place of the waveform lookup table 208. Therefore, further memory space can be saved. In various aspects, the execution component 112 can apply translations on the subset 402 to provide the NCO with the correct waveform. As a non-limiting example, the waveform lookup table 208 can comprise a sinusoid wave spanning a complete cycle (e.g., spanning 360 degrees). To further reduce memory requirements, the subset 402 can store half of the sinusoid wave (e.g., spanning 180 degrees). In some cases, the subset 402 can store any half of the sinusoid wave (e.g., spanning 180 to 360 degrees, spanning 0 to 180 degrees, spanning 0 to 90 degrees and 270 to 360 degrees). As another non-limiting example, the subset 402 can store a quarter of the sinusoid wave. In any case, the execution component 112 can apply any suitable transformation (e.g., reflect over x-axis, reflect over y-axis) to the waveform stored in subset 402 to acquire the kernel 212 corresponding to frequency 202 and phase 204.

Similar to waveform lookup table 208, in various embodiments, the subset 402 can be shared between the logic blocks 206. Accordingly, any suitable schema can be implemented to facilitate access to the subset 402 among the logic blocks 206. For example, an arbitrator can be implemented to determine priority among the logic blocks 206 and coordinate access requests to the subset 402. In various instances, the arbitrator can be implemented using hardware, a combination of hardware and software, software, or software in execution.

Turning to FIG. 5, one or more embodiments described herein can include one or more devices, systems and/or apparatuses that can provide a process to facilitate qubit differentiation with a numerically controlled oscillator (NCO) kernel. Accordingly, at FIG. 5, illustrated is a block diagram of an example, non-limiting system 500 that can at least partially facilitate such a process. While referring here to one or more processes, facilitations and/or uses of the non-limiting system 500, description provided herein, both above and below, also can be relevant to one or more other non-limiting systems described herein, such as the non-limiting system 100.

As illustrated at FIG. 5, the non-limiting system 500 can comprise a quantum system 502 that can be employed with or separate from the classical system 102.

Generally, the quantum system 502 (e.g., quantum computer system, superconducting quantum computer system and/or the like) can employ quantum algorithms and/or quantum circuitry, including computing components and/or devices, to perform quantum operations and/or functions on input data to produce results that can be output to an entity. The quantum circuitry can comprise quantum bits (qubits), such as multi-bit qubits, physical circuit level components, high level components and/or functions. The quantum circuity can comprise physical pulses that can be structured (e.g., arranged and/or designed) to perform desired quantum functions and/or computations on data (e.g., input data and/or intermediate data derived from input data) to produce one or more quantum results as an output. The quantum results, e.g., quantum measurement readout 520, can be responsive to the quantum job request 524 and associated input data and can be based at least in part on the input data, quantum functions and/or quantum computations.

In one or more embodiments, the quantum system 502 can comprise components, such as a quantum operation component 503, a quantum processor 506, pulse component 410 (e.g., a waveform generator) and/or a readout electronics 512 (e.g., readout component). In one or more other embodiments, the readout electronics 512 can be comprised at least partially by the classical system 102 and/or be external to the quantum system 502. The quantum processor 506 can comprise one or more, such as plural, qubits 507. Individual qubits 507A, 507B and 507C, for example, can be fixed frequency and/or single junction qubits, such as transmon qubits.

In one or more embodiments, a memory 516 and/or processor 514 can be associated with the quantum operation component 503, where suitable. The processor 514 can be any suitable processor. The processor 514 can generate one or more instructions for controlling the one or more processes of the quantum operation component 503.

The quantum operation component 503 can obtain (e.g., download, receive, search for and/or the like) a quantum job request 524 requesting execution of one or more quantum programs and/or a physical qubit layout. The quantum job request 524 can be provided in any suitable format, such as a text format, binary format and/or another suitable format. In one or more embodiments, the quantum job request 524 can be obtained by a component other than of the quantum system 502, such as a by a component of the classical system 102.

The quantum operation component 503 can determine mapping of one or more quantum logic circuits for executing a quantum program. In one or more embodiments, the quantum operation component 503 and/or quantum processor 506 can direct the waveform generator 510 to generate one or more pulses, tones, waveforms and/or the like to affect one or more qubits 507, such as in response to a quantum job request 524.

The waveform generator 510 can generally cause the quantum processor 506 to perform one or more quantum processes, calculations and/or measurements by creating a suitable electro-magnetic signal. For example, the waveform generator 510 can operate one or more qubit effectors, such as qubit oscillators, harmonic oscillators, pulse generators and/or the like to cause one or more pulses to stimulate and/or manipulate the state(s) of the one or more qubits 507 comprised by the quantum system 502.

The quantum processor 506 and a portion or all of the waveform generator 510 can be contained in a cryogenic environment, such as generated by a cryogenic environment 517, such as effected by a dilution refrigerator. Indeed, a signal can be generated by the waveform generator 510 to affect one or more of the plurality of qubits 507. Where the plurality of qubits 507 are superconducting qubits, cryogenic temperatures, such as about 4K or lower, can be employed for function of these physical qubits. Accordingly, one or more elements of the readout electronics 512 also can be constructed to perform at such cryogenic temperatures.

The readout electronics 512, or at least a portion thereof, can be contained in the cryogenic environment 517, such as for reading a state, frequency and/or other characteristic of qubit, excited, decaying or otherwise.

It is noted that the aforementioned description(s) refer(s) to the operation of a single set of instructions run on a single qubit. However, scaling can be achieved. For example, instructions can be calculated, transmitted, employed and/or otherwise used relative to one or more qubits (e.g., non-neighbor qubits) in parallel with one another, one or more quantum circuits in parallel with one another, and/or one or more qubit mappings in parallel with one another.

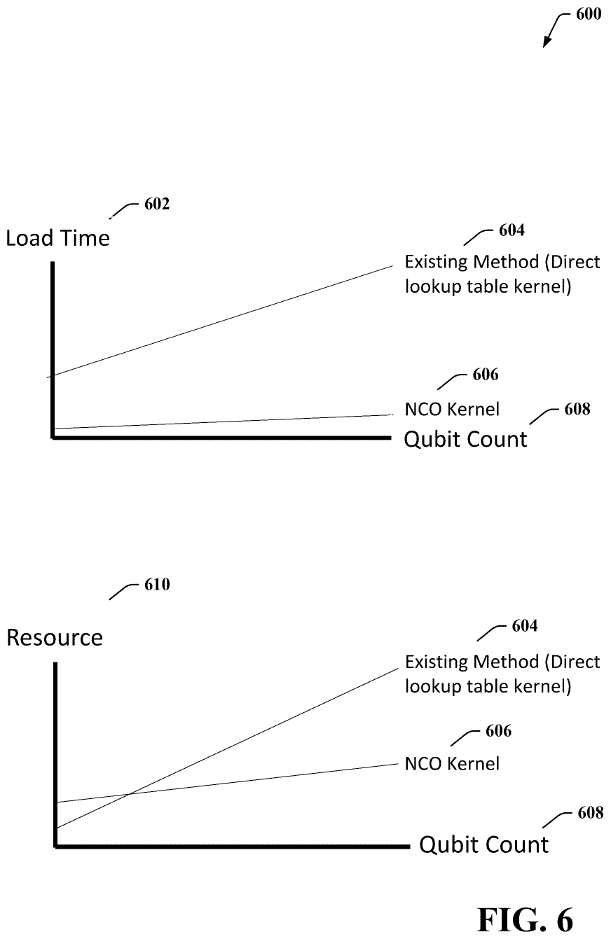

FIG. 6 illustrates a non-limiting example diagram 600 of resource utilization and load time of NCO kernels in accordance with one or more embodiments described herein. Repetitive description of like elements employed in other embodiments described herein is omitted for sake of brevity.

Illustrated in chart 602 is an example diagram of load time of existing methods 604 and the proposed methods 606 described herein. As shown, existing methods 604 require more load-time than the proposed methods 606 described herein as a qubit count 608 of a quantum system increases. Existing methods can comprise pre-computing kernels for quantum state measurements and loading the pre-computed kernels into memory of an integrated circuit. Conversely, by utilizing an NCO kernel, pre-computation of kernels can be eliminated by generating the kernels during run-time, thereby eliminating load time of the kernels no matter the qubit count 608.

Illustrated in chart 610 is an example diagram of resource utilization of existing methods 604 and the proposed methods 606 described herein. As shown, existing methods 604 require more computational resources than the proposed methods 606 described herein as the qubit count 608 of the quantum system increases. In particular, by utilizing an NCO kernel, memory requirements can be significantly reduced by eliminating a need to load pre-computed kernels into the memory, thereby reducing resource utilization. Furthermore, the waveform lookup table 208 can act as a shared memory unit across one or more logic blocks each comprising an NCO kernel, and thus maintaining a fixed memory size as the quantum system scales.

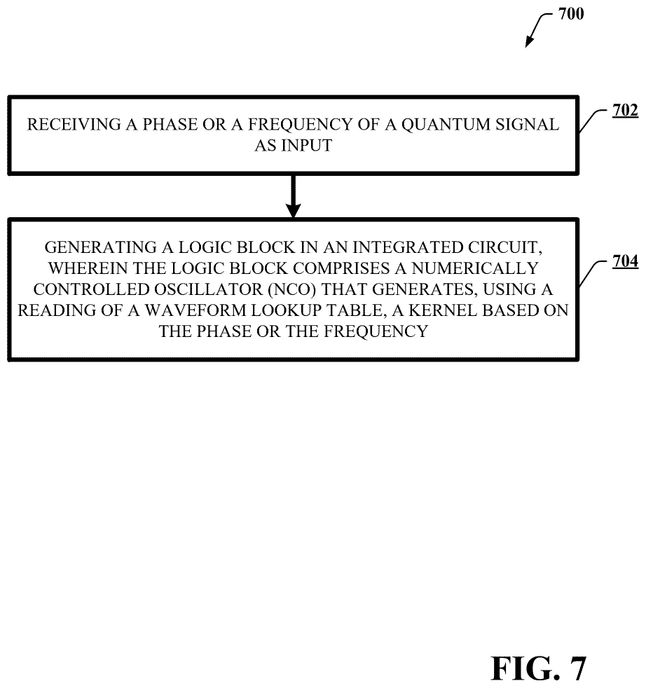

FIG. 7 illustrates a flow diagram of an example, non-limiting, computer implemented method 700 that facilitates an NCO kernel for qubit state determination in accordance with one or more embodiments described herein. Repetitive description of like elements employed in other embodiments described herein is omitted for sake of brevity.

At 702, method 700 can comprise receiving, by a system (e.g., input component 110) operatively coupled to a processor (e.g., processor 104), a phase or a frequency of a quantum signal as input. In various aspects, the phase or the frequency can indicate a desired waveform to be generated. For example, the phase or the frequency can correspond to a quantum signal that is transmitted through a qubit of a quantum system via a readout resonator.

At 704, method 700 can comprise generating, by the system (e.g., execution component 112), a logic block in an integrated circuit, wherein the logic block comprises an NCO that generates, using a reading of a waveform lookup table, a kernel based on the phase or the frequency. In various instances, the waveform lookup table can instead store a subset of a waveform to reduce memory requirements.

In some cases, more than one phase or frequency can be received as input. More specifically, after convolving the kernel with the incoming quantum signal to determine the state of the qubit, another phase or frequency can be received to generate another kernel to determine a qubit state of a different qubit in the quantum system. Any number of phases or frequencies can be received as input to generate any number of kernels.

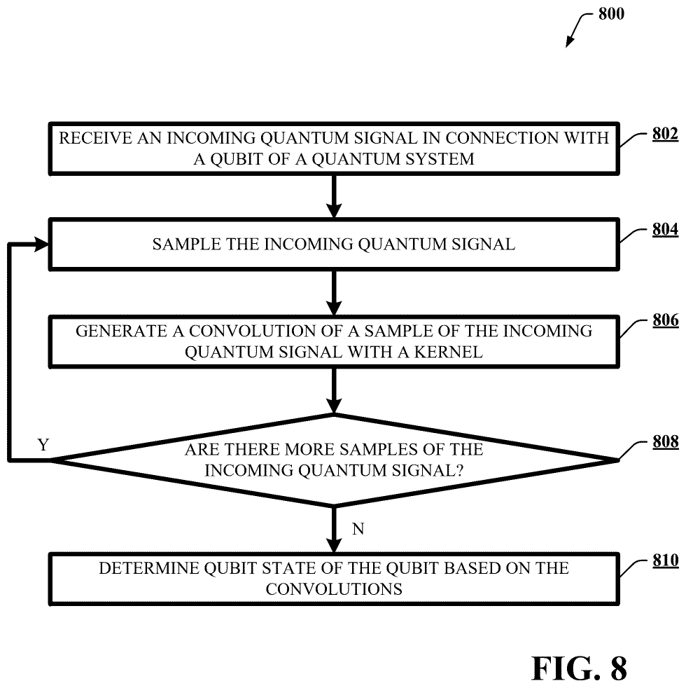

FIG. 8 illustrates a flow diagram of an example, non-limiting, computer implemented method 800 that facilitates an NCO kernel for qubit state determination in accordance with one or more embodiments described herein. Repetitive description of like elements employed in other embodiments described herein is omitted for sake of brevity.

At 802, method 800 can comprise receiving, by the system (e.g., input component 110), an incoming quantum signal in connection with a qubit of a quantum system. In various aspects, the incoming quantum signal can have been transmitted via a readout resonator through a qubit of a quantum system, wherein a measurement of the state of the qubit is desired. In various cases, the incoming quantum signal can have been influenced by the state of the qubit before being received by the input component 110.

At 804, method 800 can comprise sampling, by the system (e.g., input component 110), the incoming quantum signal. In various embodiments, the input component 110 can digitize the incoming quantum signal. More specifically, the incoming quantum signal can be converted into a digital set of discrete values that represent the incoming quantum signal. In various aspects, the input component 110 can sample the set of discrete values (e.g., sample the first datapoint of the set of discrete values).

At 806, method 800 can comprise generating, by the system (e.g., execution component 112), a convolution of a sample of the quantum signal with a kernel. In various aspects, a kernel corresponding to an input frequency and phase can have been generated by the NCO. In various instances, the execution component 112 can generate a convolution of the sampled set of discrete values representing the incoming quantum signal with the kernel.

At 808, method 800 can comprise determining if there are more samples of the quantum signal. If so (e.g., there are more samples of the quantum signal), the method 800 can proceed to 804. If not (e.g., there are no more samples of the quantum signal), the method 800 can proceed to 810. In various embodiments, the execution component 112 can generate a convolution with the kernel for each sample of the incoming quantum signal.

At 810, method 800 can comprise determining, by the system, (e.g., execution component 112), a qubit state of the qubit based on the convolutions. In various aspects, the execution component 112 can accumulate the convolutions and generate a result to determine the qubit state. For example, the execution component 112 can sum the products of each of the set of discrete values with the kernel to compute the result. Thus, based on the result, a state measurement of the qubit can be determined.

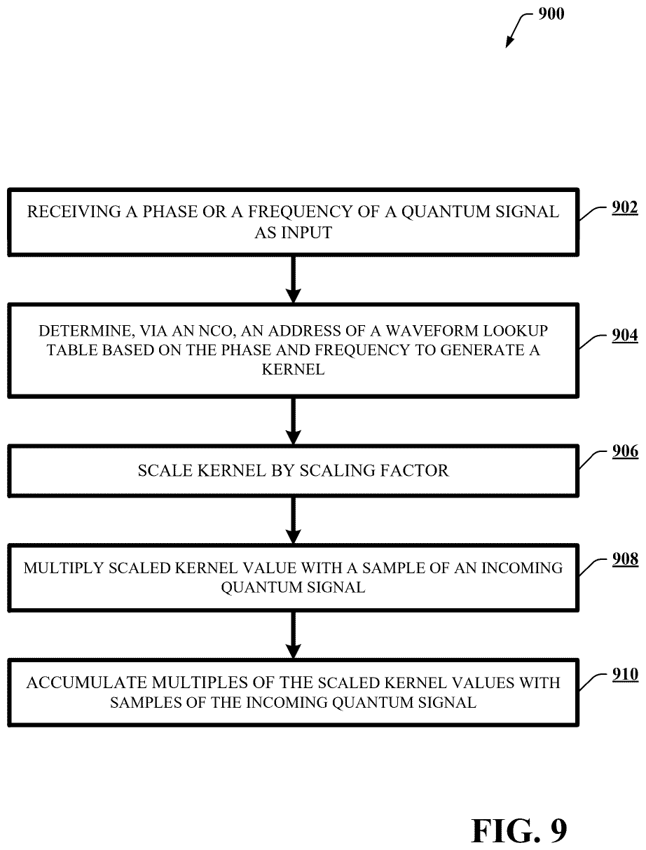

FIG. 9 illustrates a flow diagram of an example, non-limiting, computer implemented method 900 that facilitates an NCO kernel for qubit state determination in accordance with one or more embodiments described herein. Repetitive description of like elements employed in other embodiments described herein is omitted for sake of brevity.

At 902, method 900 can comprise receiving, by the system (e.g., input component 110), a phase or a frequency of a quantum signal as input.

At 904, method 900 can comprise determining, by the system (e.g., execution component 112), via an NCO, an address of a waveform lookup table based on the phase and frequency to generate a kernel. In various aspects, the NCO can determine the address via a phase accumulator. The phase accumulator can increment the phase based on a clock cycle to control the frequency of the output. In various cases, the output of the phase accumulator can be used as an index or the address of the waveform lookup table to generate a waveform as the kernel.

At 906, method 900 can comprise classically scaling, by the system, (e.g., execution component 112), the kernel by a scaling factor.

At 908, method 900 can comprise multiplying, by the system (e.g., execution component 112), a scaled kernel value with a sample of incoming quantum signal. In various aspects, the execution component 112 can convolve the sample of the incoming quantum signal with the scaled kernel value.

At 910, method 900 can comprise accumulating, by the system (e.g., execution component 112), multiples of the scaled kernel values with samples of the incoming quantum signal. For example, accumulating the multiples of the scaled kernel values with samples of the incoming quantum signal can comprise generating a sum of the multiples.

NCO kernel system 102 can provide technical improvements to a processing unit associated with NCO kernel system 102. For example, by utilizing NCO kernels, pre-compute times and load times of kernels can be eliminated, thereby reducing the workload of a processing unit (e.g., processor 104) that is employed to execute routines (e.g., instructions and/or processing threads) involved in computations. In this example, by reducing the workload of such a processing unit (e.g., processor 104), NCO kernel system 102 can thereby facilitate improved performance, improved efficiency, and/or reduced computational cost associated with such a processing unit. Further, by utilizing NCO kernels, memory requirements for quantum state determination by NCO kernel system 102 is reduced, thereby improving efficiency and/or reduced computational resources associated with such a processing unit.

A practical application of NCO kernel system 102 is that it allows for scaling to larger quantum systems (e.g., more qubits) utilizing a reduced amount of computing and/or network resources, in comparison to other methods. For example, utilization of NCO kernels reduces memory requirements in the integrated circuit for the kernel. More specifically, NCO kernels can eliminate kernel generation, and therefore eliminate kernel pre-compute times and load times. Furthermore, a unified shared memory space can maintain the kernel memory size required as the quantum system size scales, thereby reducing resource requirements, reducing load times, and mitigating crosstalk by the NCO kernel system 102. Therefore, NCO kernel system 102 can enable quantum state determination to be performed with reduced hardware requirements, thus promoting scalability of quantum systems. Furthermore, by eliminating the load times of the kernels, execution time of quantum experiments for quantum state determination is reduced, improving performance of quantum systems and/or quantum computers utilized in quantum state determination.

It is to be appreciated that NCO kernel system 102 can utilize various combination of electrical components, mechanical components, and circuity that cannot be replicated in the mind of a human or performed by a human as the various operations that can be executed by NCO kernel system 102 and/or components thereof as described herein are operations that are greater than the capability of a human mind. For instance, the amount of data processed, the speed of processing such data, or the types of data processed by NCO kernel system 102 over a certain period of time can be greater, faster, or different than the amount, speed, or data type that can be processed by a human mind over the same period of time. According to several embodiments, NCO kernel system 102 can also be fully operational towards performing one or more other functions (e.g., fully powered on, fully executed, and/or another function) while also performing the various operations described herein. It should be appreciated that such simultaneous multi-operational execution is beyond the capability of a human mind. It should be appreciated that NCO kernel system 102 can include information that is impossible to obtain manually by an entity, such as a human user. For example, the type, amount, and/or variety of information included in NCO kernel system 102 can be more complex than information obtained manually by an entity, such as a human user.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

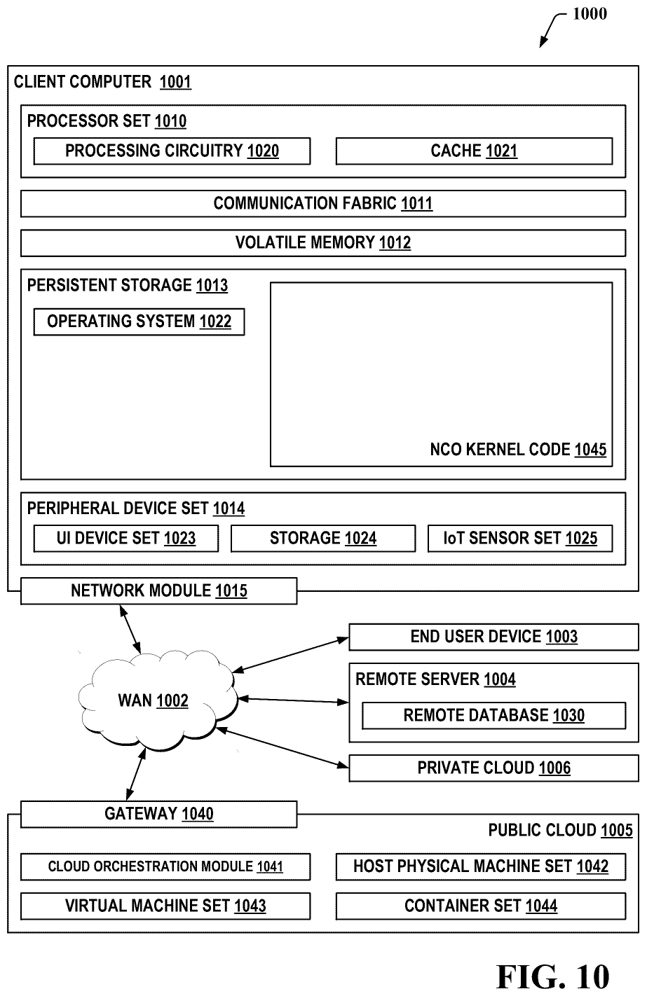

FIG. 10 and the following discussion are intended to provide a brief, general description of a suitable computing environment 1000 in which one or more embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as generation of kernels during run-time, generating kernels via an NCO, and/or generating kernels without length constraints with NCO kernel code 1045. In addition to block 1045, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1045, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method can be distributed among multiple computers and/or between multiple locations. On the other hand, in this presentation of computing environment 1000, detailed discussion is focused on a single computer, specifically computer 1001, to keep the presentation as simple as possible. Computer 1001 can be located in a cloud, even though it is not shown in a cloud in FIG. 10. On the other hand, computer 1001 is not required to be in a cloud except to any extent as can be affirmatively indicated.

PROCESSOR SET 1010 includes one, or more, computer processors of any type now known or to be developed in the future. Processing circuitry 1020 can be distributed over multiple packages, for example, multiple, coordinated integrated circuit chips. Processing circuitry 1020 can implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set can be located “off chip.” In some computing environments, processor set 1010 can be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods can be stored in block 1045 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory can be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 can be a read only memory (ROM), but typically at least a portion of the persistent storage allows writing of data, deletion of data and re-writing of data. Some familiar forms of persistent storage include magnetic disks and solid-state storage devices. Operating system 1022 can take several forms, such as various known proprietary operating systems or open-source Portable Operating System Interface type operating systems that employ a kernel. The code included in block 1045 typically includes at least some of the computer code involved in performing the inventive methods.

PERIPHERAL DEVICE SET 1014 includes the set of peripheral devices of computer 1001. Data communication connections between the peripheral devices and the other components of computer 1001 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 can include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 can be persistent and/or volatile. In some embodiments, storage 1024 can take the form of a quantum computing storage device for storing data in the form of qubits. In embodiments where computer 1001 is required to have a large amount of storage (for example, where computer 1001 locally stores and manages a large database) then this storage can be provided by peripheral storage devices designed for storing large amounts of data, such as a storage area network (SAN) that is shared by multiple, geographically distributed computers. IoT sensor set 1025 is made up of sensors that can be used in Internet of Things applications. For example, one sensor can be a thermometer and another sensor can be a motion detector.

NETWORK MODULE 1015 is the collection of computer software, hardware, and firmware that allows computer 1001 to communicate with other computers through WAN 1002. Network module 1015 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001) and can take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 can be a client device, such as thin client, heavy client, mainframe computer and/or desktop computer.

REMOTE SERVER 1004 is any computer system that serves at least some data and/or functionality to computer 1001. Remote server 1004 can be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data can be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs can be stored as images and can be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware and firmware allowing public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1175 and private cloud 1176 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor, operably coupled to the memory, that executes the computer executable components stored in the memory, wherein the computer executable components comprise:
an input component that receives a setpoint having a phase or a frequency for a quantum signal as input; and
an execution component that generates a kernel based on the setpoint for the quantum signal using a logic block in an integrated circuit, wherein the logic block comprises a numerically controlled oscillator (NCO) that generates the kernel using a reading of a waveform lookup table.

2. The system of claim 1, wherein the execution component generates one or more convolutions of a sample of an incoming signal in connection with a qubit of a quantum system with the kernel.

3. The system of claim 2, wherein the execution component accumulates the one or more convolutions to determine a qubit state of the qubit.

4. The system of claim 1, wherein the waveform lookup table stores a quarter of a sine wave, and wherein the execution component performs a translation on the quarter of the sine wave to generate the kernel based on the setpoint for the quantum signal.

5. The system of claim 1, wherein the execution component generates more than one kernel using a plurality of logic blocks in the integrated circuit, and wherein the waveform lookup table is shared between the plurality of logic blocks.

6. The system of claim 5, wherein the more than one logic blocks are configured to determine different qubit measurements.

7. The system of claim 1, wherein the waveform lookup table comprises a fixed memory size in the integrated circuit.

8. The system of claim 1, wherein the execution component scales the kernel by a scaling factor.

9. The system of claim 1, wherein the logic block in the integrated circuit is implemented using a Field-Programmable Gate Array (FPGA) or an Application-Specific Integrated Circuit (ASIC).

10. A unit cell of an Application-Specific Integrated Circuit (ASIC), the unit cell comprising:
a memory that stores a waveform lookup table; and
a logic block coupled to the memory, the logic block comprising:
registers that store a setpoint having a phase or a frequency for a quantum signal; and
a numerically controlled oscillator (NCO), coupled to the registers, that generates a kernel based on the setpoint for the quantum signal using a reading of the waveform lookup table.

11. The unit cell of claim 10, further comprising:
an analog-to-digital converter (ADC), coupled to the logic block, that samples an incoming signal in connection with a qubit of a quantum system; and
a multiply-accumulate unit, coupled to the ADC, that generates one or more convolutions of a sample of the incoming signal with the kernel.

12. The unit cell of claim 10, wherein the waveform lookup table stores a quarter of a sine wave, and wherein generating the kernel comprises:
performing a translation on the quarter of the sine wave based on the setpoint for the quantum signal.

13. The unit cell of claim 10, further comprising:
a plurality of logic blocks, wherein the waveform lookup table is shared between the plurality of logic blocks.

14. The unit cell of claim 13, wherein the more than one logic blocks are configured to determine different qubit measurements.

15. The unit cell of claim 11, further comprising:
a controller that outputs a reset signal to the NCO, the ADC, or the multiply-accumulate unit to coordinate acquisition of the setpoint.

16. The unit cell of claim 10, wherein the registers store a scaling factor for scaling the kernel.

17. A computer program product facilitating a process to perform qubit differentiation with a numerically controlled oscillator (NCO) kernel, the computer program product comprising a computer readable storage medium having program instructions embodied therewith, the program instructions executable by a processor to cause the processor to:
receive, by the processor, a setpoint having a phase or a frequency for a quantum signal as input; and
generate, by the processor, a kernel based on the setpoint for the quantum signal using a logic block in an integrated circuit, wherein the logic block comprises a numerically controlled oscillator (NCO) that generates the kernel using a reading of a waveform lookup table.

18. The computer program product of claim 17, wherein the program instructions are further executable by the processor to cause the processor to:
generate one or more convolutions of a sample of an incoming signal in connection with a qubit of a quantum system with the kernel.

19. The computer program product of claim 18, wherein the program instructions are further executable by the processor to cause the processor to:
accumulate the one or more convolutions to determine a qubit state of the qubit.

20. The computer program product of claim 17, wherein the program instructions are further executable by the processor to cause the processor to:
generate more than one kernel using a plurality of logic blocks in the integrated circuit, and wherein the waveform lookup table is shared between the plurality of logic blocks.
